(19) United States
(12) Patent Application Publication
(10) Pub. No.: US 2026/0261977 A1
(43) Pub. Date: Sep. 3, 2026

(54) SUPPORT RADIO ACCESS NETWORK SLEEP AND WAKEUP IN FRONTHAUL

(71) Applicant: Telefonaktiebolaget LM Ericsson (publ), Stockholm (SE)

(72) Inventors: Yanxing Liu, Beijing (CN); Shujie Yang, Beijing (CN); Xiang Li, Beijing (CN)

(21) Appl. No.: 19/489,443

(22) PCT Filed: Jun. 8, 2023
(86) PCT No.: PCT/CN2023/099045

§ 371 Date: Dec. 2, 2025

(51) Int. Cl. H04W 52/02; H04W 76/40

(52) U.S. Cl. CPC H04W 52/0235; H04W 76/40

(57) ABSTRACT

Please replace the Abstract with the following replacement Abstract:

A transport node, a baseband unit (BBU), and methods for support Radio Access Network (RAN) sleep and/or wake up in the Fronthaul. The method implemented at transport node in a Fronthaul comprises receiving a first sleep message, a first wakeup message, a first signal for sleep, and/or a first signal for wakeup, originated from the BBU. The method further comprises transmitting a second sleep message and/or a second signal of a laser for sleep, to transit the RU to a sleep mode, and turning off the laser, in response to the reception of the first sleep message and/or the first signal for sleep; and/or transmitting a second wakeup message and/or a second signal of a laser for wakeup, to wake up the RU, in response to the reception of the first wakeup message and/or the first signal for wakeup.

### TECHNICAL FIELD

The present disclosure is related to the field of telecommunication, and in particular, to a transport node, a baseband unit (BBU), and methods for support Radio Access Network (RAN) sleep and wake up in the scenario that a Fronthaul is between the BBUs and RUs.

### BACKGROUND

Fronthaul, also known as mobile fronthaul, is a term that refers to the fiber-based connection of the cloud radio access network (C-RAN), a new type of cellular network architecture of centralized baseband units (BBUs) and remote radio heads (RRHs) at the access layer of the network.

Today's mobile networks already consume a considerable amount of energy. As we move ahead into fifth generation (5G), the energy stakes look set to get even higher. Due to huge increases in density and traffic are expected to negate these savings, leading to a net 5G energy consumption potentially 4 to 5 times higher than fourth generation (4G).

The Radio Access Network (RAN) consumes over 70% of 5G network energy, which is an essential component of Operating Expenses (OPEX) costs for any Mobile Operator. The different hardware elements in RAN such as the Radio Unit (RU), the Baseband Unit (BBU), and the transport unit, add to the overall energy consumption.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The key method to reduce 5G RAN energy consumption is to upgrade RU hardware and/or software to support deeper and deeper sleep. It depends on interworking between RU and BBU based on direct point-to-point connections. To enable deep sleep mode, the BBU sends “deep sleep” message to specific RU, and RU performs deep sleep actions. “Shutdown of SFP modules” and “turnoff of laser” are included in the deep sleep actions. To recover from deep sleep mode, the BBU turns on laser to wake up RU(s). However, the transport device, in this case, has not been considered yet.

The present disclosure proposes an improved solution for support Radio Access Network (RAN) sleep and/or wake up in the scenario that a Fronthaul is between the BBUs and RUs.

According to a first aspect of the present disclosure, a method at a transport node in a Fronthaul is provided. The transport node is connected to at least one Radio Unit (RU) and at least one Baseband Unit (BBU) is connected to the Fronthaul via the transport node or another transport node in the Fronthaul. The method comprises: receiving a first sleep message, a first wakeup message, a first signal for sleep, and/or a first signal for wakeup, originated from the BBU. The method further comprises transmitting a second sleep message and/or a second signal of a laser for sleep, to transit the RU to a sleep mode, and turning off the laser, in response to the reception of the first sleep message and/or the first signal for sleep; and/or transmitting a second wakeup message and/or a second signal of a laser for wakeup, to wake up the RU, in response to the reception of the first wakeup message and/or the first signal for wakeup .

In some embodiments, the method further comprises shutting down a Small Form Factor Pluggable (SPF) module, in response to the reception of the first sleep message and/or the first signal for sleep.

In some embodiments, the method further comprises storing a mapping relationship between the at least one RU and at least one corresponding transport port.

In some embodiments, the method further comprises determining the second sleep message and/or the second signal of a laser for sleep, based on the first sleep message and/or the first signal for sleep; or determining the second wakeup message and/or the second signal of a laser for wakeup, based on the first wakeup message and/or the first signal for wakeup.

In some embodiments, the first sleep message, the first wakeup message, the first signal for sleep, and/or the first signal for wakeup, is received directly from the BBU, or from another transport node.

In some embodiments, the first or second sleep message comprises a first timer for sleep, and/or the first or second wakeup message comprises a second timer for awake.

In some embodiments, the first or second sleep message and/or the first or second wakeup message comprises at least one of the followings: BBU identifier, sequence number, message type, message length, RU identifier.

In some embodiments, the first or second sleep message and/or the first or second wakeup message is received via unicast or multicast.

In some embodiments, the multicast is based on a Link Layer Discovery Protocol (LLDP).

In some embodiments, the reception of the sleep message and/or the wakeup message is secured by LLDP authentication header, Internet Protocol Security (IPsec), Secure Sockets Layer (SSL), and/or Media Access Control security (MACsec).

According to a second aspect of the present disclosure, an apparatus implemented in a transport node in a Fronthaul is provided. The transport node is connected to at least one Radio Unit (RU) and at least one Baseband Unit (BBU) is connected to the Fronthaul via the transport node or another transport node in the Fronthaul. The apparatus comprises: one or more processors; and one or more memories comprising computer program codes. The one or more memories and the computer program codes configured to, with the one or more processors cause, cause the apparatus to perform any of the methods of the first aspect.

According to a third aspect of the present disclosure, a method at a baseband unit (BBU) connected to a transport node in a Fronthaul is provided. The Fronthaul comprises one or more transport nodes and is further connected to at least one Radio Unit (RU). The method comprises: determining a first sleep message, a first wakeup message, a first signal for sleep, and/or a first signal for wakeup. The method further comprises: transmitting the first sleep message or the first signal for sleep to the transport node, so as to transit the RU to a sleep mode by receiving a second sleep message or a second signal of laser for sleep, and/or transmitting the first wakeup message or the first signal for wakeup to the transport node, so as to wake up the RU by receiving a second sleep message or a second signal of laser for wakeup.

In some embodiments, the first or second sleep message comprises a first timer for sleep, and/or the first or second wakeup message comprises a second timer for awake.

In some embodiments, the first or second sleep message and/or the first or second wakeup message comprises at least one of the followings: BBU identifier, Sequence number, message type, message length, RU identifier.

In some embodiments, the first or second sleep message and/or the first or second wakeup message is transmitted via unicast or multicast.

In some embodiments, the multicast is based on a Link Layer Discovery Protocol (LLDP).

In some embodiments, the transmission of the sleep message and/or the wakeup message is secured by LLDP authentication header, Internet Protocol Security (IPsec), Secure Sockets Layer (SSL), and/or Media Access Control security (MACsec).

According to a fourth aspect of the present disclosure, an apparatus implemented in a baseband unit (BBU) connected to a transport node in a Fronthaul is provided. The Fronthaul comprises one or more transport nodes and is further connected to at least one Radio Unit (RU). The apparatus comprises: one or more processors; and one or more memories comprising computer program codes. The one or more memories and the computer program codes configured to, with the one or more processors cause, cause the apparatus to perform any of the methods of the third aspect.

According to a fifth aspect of the present disclosure, a computer-readable medium having computer program codes embodied thereon for use with a computer. The computer program codes comprise codes for performing the method according to any one of the first or third aspect.

According to a sixth aspect of the present disclosure, an apparatus implemented in transport node in a Fronthaul is provided. The transport node is connected to at least one Radio Unit (RU) and at least one Baseband Unit (BBU) is connected to the Fronthaul via the transport node or another transport node in the Fronthaul. The apparatus comprises: a receiving module configured to receive a first sleep message, a first wakeup message, a first signal for sleep, and/or a first signal for wakeup, originated from the BBU. The apparatus further comprises: a transmitting module configured to transmit a second sleep message and/or a second signal of a laser for sleep, to transit the RU to a sleep mode, and turning off the laser, in response to the reception of the first sleep message and/or the first signal for sleep; and/or transmit a second wakeup message and/or a second signal of a laser for wakeup, to wake up the RU, in response to the reception of the first wakeup message and/or the first signal for wakeup.

In some embodiments, the apparatus comprises one or more further modules, each of which may perform any of the methods of the first aspect.

According to a seventh aspect of the present disclosure, an apparatus implemented in a baseband unit (BBU) connected to a transport node in a Fronthaul is provided. The Fronthaul comprises one or more transport nodes and is further connected to at least one Radio Unit (RU). The apparatus comprises: a determining module configured to determine a first sleep message, a first wakeup message, a first signal for sleep, and/or a first signal for wakeup. The apparatus further comprises: a transmitting module configured to transmit the first sleep message or the first signal for sleep to the transport node, so as to transit the RU to a sleep mode by receiving a second sleep message or a second signal of laser for sleep, and/or transmit the first wakeup message or the first signal for wakeup to the transport node, so as to wake up the RU by receiving a second sleep message or a second signal of laser for wakeup.

In some embodiments, the apparatus comprises one or more further modules, each of which may perform any of the methods of the third aspect.

With some embodiments of the present disclosure, the RU can go to sleep mode or wake up properly even connected to the Fronthaul. Therefore, the total energy consumption in the network can be decreased.

### BRIEF DESCRIPTION OF THE DRAWINGS

FIG. 1 is a diagram illustrating schematic view of Fronthaul.

FIG. 2 is a flow chart illustrating an exemplary method at a transport node according to an embodiment of the present disclosure.

FIG. 3 is a diagram illustrating an exemplary system according to an embodiment of the present disclosure.

FIG. 4A is a flow chart illustrating an exemplary method for wakeup workflow according to an embodiment of the present disclosure.

FIG. 4B is a flow chart illustrating an exemplary method for deep-sleep workflow according to an embodiment of the present disclosure.

FIG. 5A-FIG. 5C are diagrams illustrating exemplary message templates according to an embodiment of the present disclosure.

FIG. 6 is a diagram illustrating exemplary transmission protocols according to an embodiment of the present disclosure.

FIG. 7 is a flow chart illustrating an exemplary method at a baseband unit according to an embodiment of the present disclosure.

FIG. 8 schematically shows an embodiment of an arrangement according to an embodiment of the present disclosure.

FIG. 9A is a block diagram of an exemplary transport node according to an embodiment of the present disclosure.

FIG. 9B is a block diagram of an exemplary baseband unit according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G NR, the present disclosure is not limited thereto. In fact, as long as selection of cell for network access in a cell delegation scenario is involved, the inventive concept of the present disclosure may be applicable to any appropriate communication architecture, for example, to Global System for Mobile Communications (GSM) / General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5G NR, six generation (6G), etc. Therefore, one skilled in the arts could readily understand that the terms used herein may also refer to their equivalents in any other infrastructure. For example, the term “terminal device” used herein may refer to a UE, a mobile device, a mobile terminal, a mobile station, a user device, a user terminal, a wireless device, a wireless terminal, or any other equivalents. For another example, the term “network node” used herein may refer to a transmission reception point (TRP), a base station, a base transceiver station, an access point, a hot spot, a NodeB, an Evolved NodeB (eNB), a gNB, a network element, or any other equivalents.

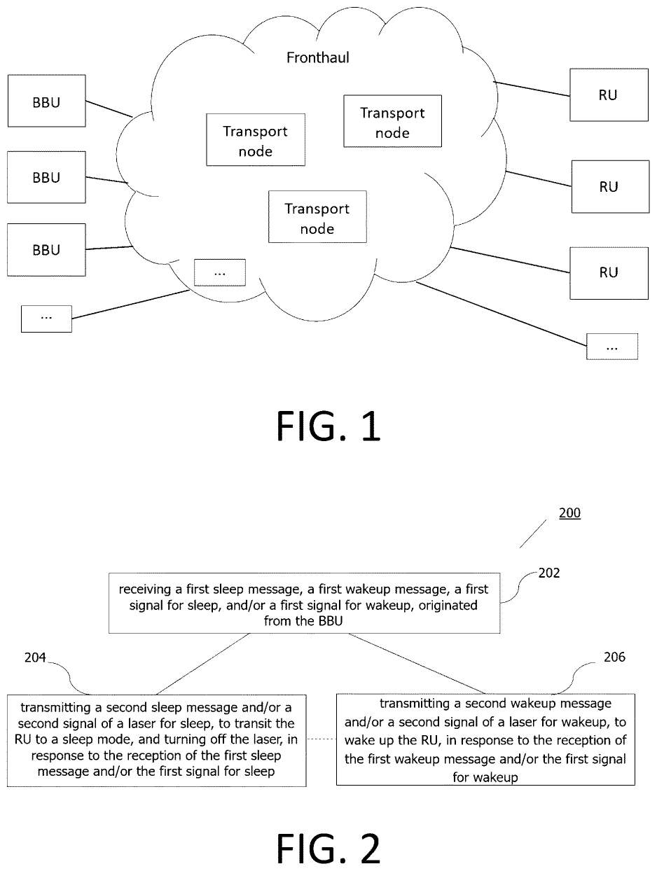

FIG. 1 is a diagram illustrating schematic view of Fronthaul. As described above, the fronthaul is defined the connection between BBU and RU. The prominent fronthaul protocols are common public radio interface (CPRI) and ethernet based CPRI (eCPRI), which define protocols to map modulated user data between RU and BBU. The switched fronthaul represents a switched infrastructure natively supports flexible RAN topologies and re-configuration dynamicity based on eCPRI protocol. The switched fronthaul is widely used in 5G and future six generation (6G).

With the switched fronthaul, the direct point-to-point connections between RU(s) and BBU(s) are broken by Transport Unit since both RU(s) and BBU(s) connect to Transport Unit. It may work with limitations when BBU sends “deep-sleep” message to enable deep-sleep mode since it may be able to encapsulate the message with eCPRI protocol and it is transparent to transport device. But it doesn't work that BBU turns on laser to wake up RU since the laser is received by transport device but not RU.

The proposed solution includes:
The BBU(s) send out wakeup message instead of turns on laser.
The Transport device receive wakeup message from BBU and interpret it to signal of laser.
In fact, the message template used by wakeup message has reserved bits to perform other functions, it is also recommended to replace existing and future deep-sleep message format (sent by BBU) with the new message format defined in this solution:
   Deep-sleep message-since the BBU doesn't have well defined deep-sleep message.
   Deep-sleep timer-RU(s) sleep for specific time.

The Transport between RUs and BBU(s) may have only one transport device, or it may be a multi-hop transport network containing multiple transport devices. Obviously, for the scenario where there is only one transport device, it is responsible for translating BBU(s) wakeup message to signal of laser to RU(s). For the scenario of transport network, the BBU(s) can choose to send message to the nearest transport device or to the remote transport device directly connected to RU(s).

FIG. 2 is a flow chart illustrating an exemplary method 200 at a transport node (e.g. a router or switch) in a Fronthaul according to an embodiment of the present disclosure. The transport node is connected to at least one Radio Unit (RU), and at least one Baseband Unit (BBU) is connected to the Fronthaul via the transport node or another transport node in the Fronthaul. The method 200 may comprise steps 202 and 204 and/or 206. However, the present disclosure is not limited thereto. In some other embodiments, the method 200 may comprise more steps, less steps, different steps, or any combination thereof. Further the steps of the method 200 may be performed in a different order than that described herein when multiple steps are involved. Further, in some embodiments, a step in the method 200 may be split into multiple sub-steps and performed by different entities, and/or multiple steps in the method 200 may be combined into a single step.

The method 200 may begin at step 202 to receive a first sleep message, a first wakeup message, a first signal for sleep, and/or a first signal for wakeup, originated from the BBU.

At step 204, the transport node transmits a second sleep message and/or a second signal of a laser for sleep, to transit the RU to a sleep mode, and turning off the laser, in response to the reception of the first sleep message and/or the first signal for sleep.

At step 206, the transport node transmits a second wakeup message and/or a second signal of a laser for wakeup, to wake up the RU, in response to the reception of the first wakeup message and/or the first signal for wakeup.

In some embodiments, the transport node may also shut down a Small Form Factor Pluggable (SPF) module, in response to the reception of the first sleep message and/or the first signal for sleep.

In some embodiments, the transport node may also store a mapping relationship between the at least one RU and at least one corresponding transport port.

In some embodiments, the transport node may also determine the second sleep message and/or the second signal of a laser for sleep, based on the first sleep message and/or the first signal for sleep; or determine the second wakeup message and/or the second signal of a laser for wakeup, based on the first wakeup message and/or the first signal for wakeup.

In some embodiments, the first sleep message, the first wakeup message, the first signal for sleep, and/or the first signal for wakeup, is received directly from the BBU, or from another transport node.

In some embodiments, the first or second sleep message comprises a first timer for sleep, and/or the first or second wakeup message comprises a second timer for awake.

In some embodiments, the first or second sleep message and/or the first or second wakeup message comprises at least one of the followings: BBU identifier, sequence number, message type, message length, RU identifier.

In some embodiments, the first or second sleep message and/or the first or second wakeup message is received via unicast or multicast.

In some embodiments, the multicast is based on a Link Layer Discovery Protocol (LLDP).

In some embodiments, the transmission of the sleep message and/or the wakeup message is secured by LLDP authentication header, Internet Protocol Security (IPsec), Secure Sockets Layer (SSL), and/or Media Access Control security (MACsec).

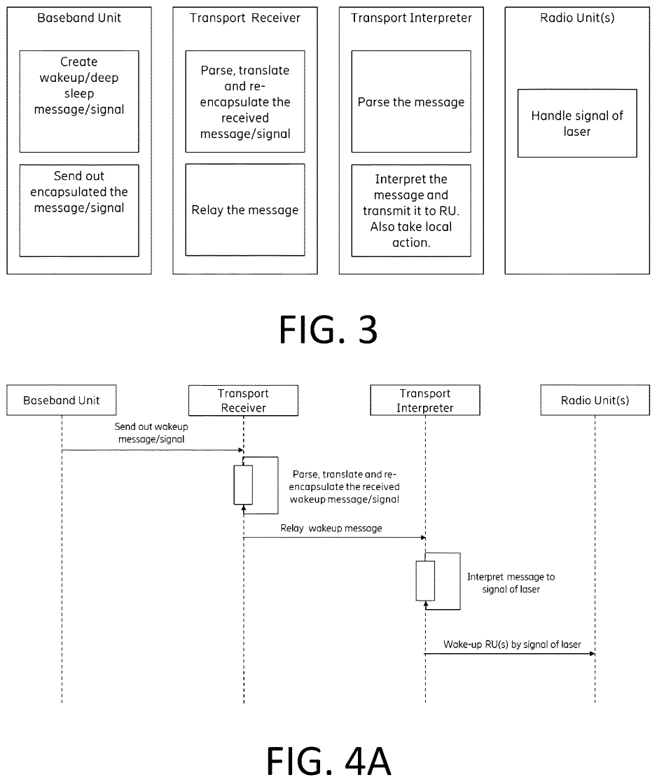

FIG. 3 is a diagram illustrating an exemplary system according to an embodiment of the present disclosure. The Transport Receiver and Transport Interpreter can be implemented in one transport node, or different transport nodes.

Following will be the key advantages of the proposed solution:
Enable energy efficiency of RAN in (switched) Fronthaul
Key differentiator in RAN and Transport integrated solution

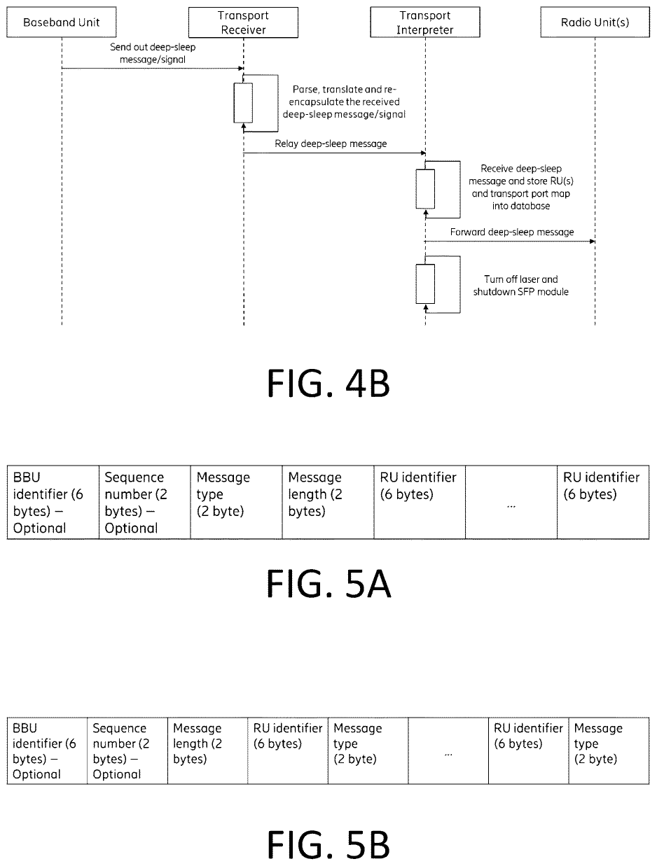

FIG. 4A is a flow chart illustrating an exemplary method for wakeup workflow according to an embodiment of the present disclosure. FIG. 4B is a flow chart illustrating an exemplary method for deep-sleep workflow according to an embodiment of the present disclosure.

The BBU creates wakeup/deep-sleep message/signal, signal needs to be translated in message.

The BBU sends out wakeup/deep-sleep message carried by transmission protocols.

The transport receiver is the start transport unit which connects to BBU(s) and the transport interpreter is the end transport which connects to RU(s). In real deployment they can be in one physical transport unit or multiple transport units. The transport receiver receives wakeup/deep-sleep message/signal from BBU and parse it, translate it and re-encapsulate it before relays it with defined transmission protocols to transport interpreter.

The transport interpreter handles the received message according to message type. The interpreter function is normally added to the software of transmission protocol which encapsulate the wakeup/deep-sleep message and transmit in transport network.

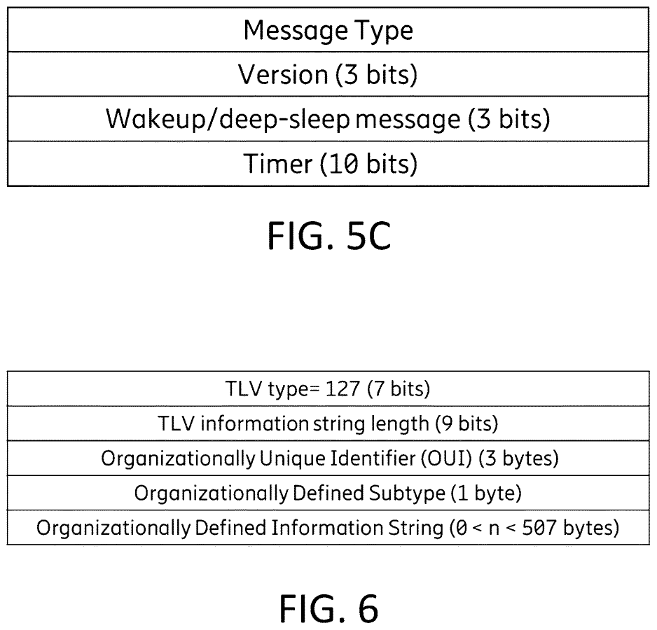

FIG. 5A-FIG. 5C are diagrams illustrating exemplary message templates according to an embodiment of the present disclosure.

FIG. 5A and FIG. 5B are examples of the templates of wakeup/deep-sleep message, in which 1 byte is equal to 8 bits.

BBU identifier can be optional field which is Media Access Control (MAC) address or other identity of BBU.

Sequence number can be optional field which is sequence identity (ID) of specific wakeup message.

Message type represents different message type as shown in FIG. 5C. As an example:
The first highest three bits represent version of wakeup/deep-sleep message.
The next 3 bits “101″ represent wakeup message.
The next 3 bits ”011″ represent sleep message.
The last 10 bits represent timer which means how long time the RU(s) will sleep.
The other combinations are reserved.

Message length is the length of following message body.

RU identifier can be optional field which is MAC address or other identity of RU.

The wakeup/deep-sleep message can be transmitted by multicast or unicast.

The Link Layer Discovery Protocol (LLDP) can be used as multicast transmission. And the definition of Type Length Value (TLV) follows what LLDP specified “The LLDP specification allows for various organizations to define and encode their own TLVs. These are called Organizationally Specific TLVs. All Organizationally Specific TLVs start with an LLDP TLV Type value of 127.” The new TLV for wakeup message is shown in FIG. 6

All bits of Organizationally Unique Identifier (OUI) and Organizationally Defined Subtype can be to “1” to avoid conflict with the organizations have published Organizationally Specific TL Vs. The wakeup message can fill into the field of Organizationally Defined Information String and to be noted that the length of wakeup message needs to be less than 507 bytes. The advantage to use LLDP is the destination field can be fixed MAC address 01:80:c2:00:00:0e. But it also requires the transport receiver to relay this LLDP message.

If the BBU holds mapping between RU(s) and its directly connected transport device, the wakeup message can be transmitted by unicast. It can leverage mature/legacy Transmission Control Protocol/Internet Protocol (TCP/IP) communication technology to establish TCP socket connection between BBU and the RU directly connected transport device. The socket number needs to be carefully defined to avoid conflict. Besides TCP socket another solution is to use raw socket.

Finally, when the transport device which directly connected to specific RU receives wakeup/deep-sleep message/signal from BBU, it interprets the wakeup message to signal of laser at the ports connected with specific RU(s). And locally to transport device, it interprets the deep-sleep message to turn off laser and shutdown SFP module after transport device transmitting the deep-sleep message to specific RU(s).

When transmit message between BBU to transport device, security needs to be considered, LLDP security can follow proprietary LLDP authentication header. TCP socket needs Internet Protocol Security (IPsec) or Secure Sockets Layer (SSL) to secure the TCP connection. Raw socket can leverage raw socket over IPsec as security solution. In fact, all ethernet packets can be secured by Media Access Control security (MACsec).

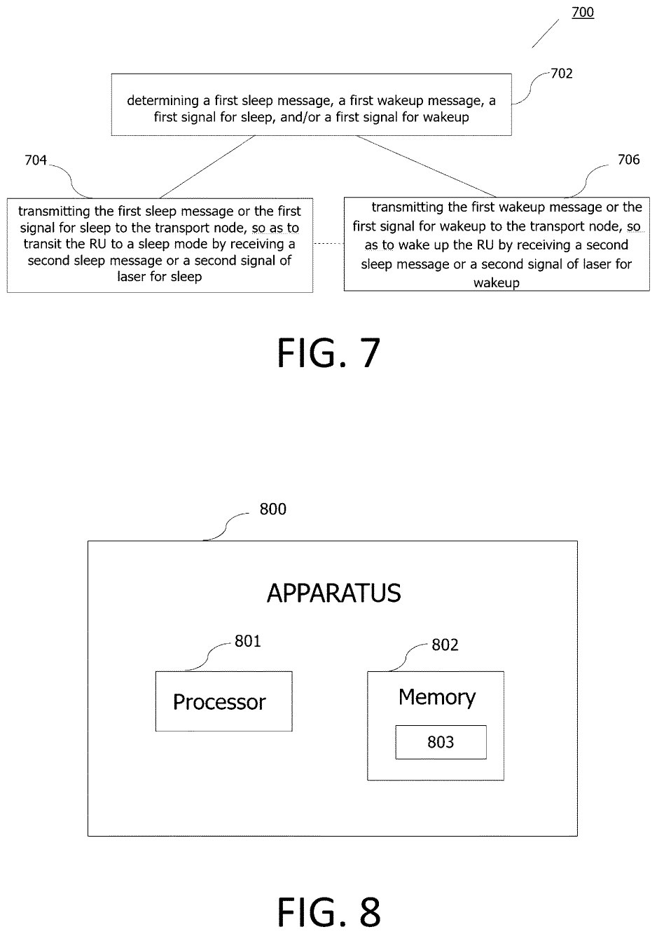

FIG. 7 is a flow chart illustrating an exemplary method 700 at a baseband unit (BBU) connected to a transport node in a Fronthaul according to an embodiment of the present disclosure. The Fronthaul comprises one or more transport nodes and is further connected to at least one Radio Unit (RU). The method 700 may comprise steps 702 and 704 and/or 706. However, the present disclosure is not limited thereto. In some other embodiments, the method 700 may comprise more steps, less steps, different steps, or any combination thereof. Further the steps of the method 700 may be performed in a different order than that described herein when multiple steps are involved. Further, in some embodiments, a step in the method 700 may be split into multiple sub-steps and performed by different entities, and/or multiple steps in the method 700 may be combined into a single step.

The method 700 may begin at step 702 to determine a first sleep message, a first wakeup message, a first signal for sleep, and/or a first signal for wakeup.

At step 704, the BBU transmits the first sleep message or the first signal for sleep to the transport node, so as to transit the RU to a sleep mode by receiving a second sleep message or a second signal of laser for sleep.

At step 706, the BBU transmits the first wakeup message or the first signal for wakeup to the transport node, so as to wake up the RU by receiving a second sleep message or a second signal of laser for wakeup.

In some embodiments, the first or second sleep message comprises a first timer for sleep, and/or the first or second wakeup message comprises a second timer for awake.

In some embodiments, the first or second sleep message and/or the first or second wakeup message comprises at least one of the followings: BBU identifier, Sequence number, message type, message length, RU identifier.

In some embodiments, the first or second sleep message and/or the first or second wakeup message is transmitted via unicast or multicast.

In some embodiments, the multicast is based on a Link Layer Discovery Protocol (LLDP).

In some embodiments, the transmission of the sleep message and/or the wakeup message is secured by LLDP authentication header, Internet Protocol Security (IPsec), Secure Sockets Layer (SSL), and/or Media Access Control security (MACsec).

The exemplary embodiments are the same as described above and will not be described again.

FIG. 8 is a block diagram illustrating an apparatus 800 according to various embodiments of the present disclosure. As shown in FIG. 8, the apparatus 800 may comprise one or more processors such as processor 801, and one or more memories such as memory 802, storing computer program codes 803. The memory 802 may be non-transitory machine/processor/computer readable storage medium. In accordance with some exemplary embodiments, the apparatus 800 may be implemented as an integrated circuit chip or module that can be plugged or installed into a transport node as described with respect to FIG. 2, and a baseband unit (BBU) as described with respect to FIG. 7.

In some implementations, the one or more memories 802, and the computer program codes 803, may be configured to, with the one or more processors 801, cause the apparatus 800 at least to perform any operation of the method as described in connection with FIG. 2 and FIG. 7. In other implementations, the one or more memories 802, and the computer program codes 803, may be configured to, with the one or more processors 801, cause the apparatus 800 at least to perform any operation of the method as described in connection with FIG. 2 and FIG. 7.

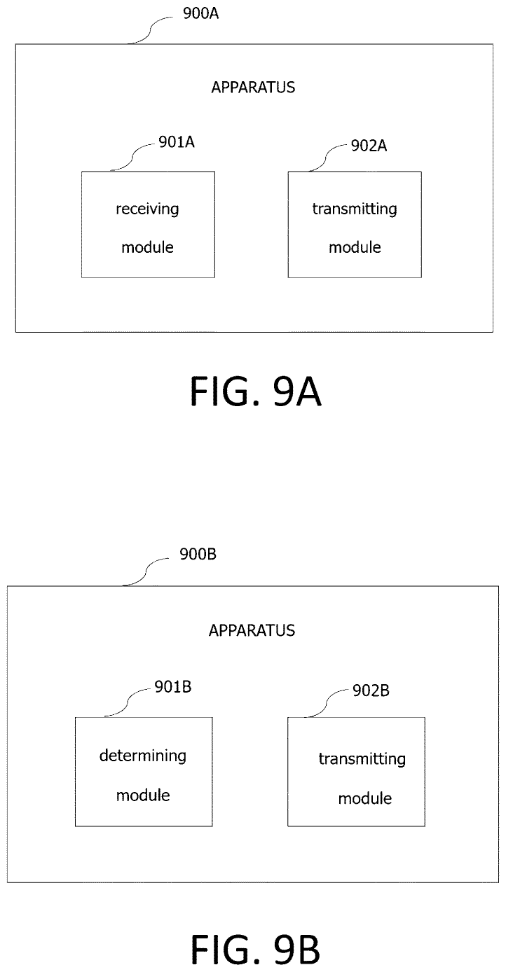

Correspondingly to the method 200 as described above, an exemplary apparatus implemented in a transport node in a Fronthaul is provided. The transport node is connected to at least one Radio Unit (RU) and at least one Baseband Unit (BBU) is connected to the Fronthaul via the transport node or another transport node in the Fronthaul. FIG. 9A is a block diagram of the apparatus 900A according to an embodiment of the present disclosure. The apparatus 900A may be, e.g., the router or switch in some embodiments.

The apparatus 900A may be configured to perform the method 200 as described above in connection with FIG. 2. As shown in FIG. 9A, the apparatus 900A may comprise: a receiving module 901A configured to receive a first sleep message, a first wakeup message, a first signal for sleep, and/or a first signal for wakeup, originated from the BBU; and a receiving module 902A configured to transmit a second sleep message and/or a second signal of a laser for sleep, to transit the RU to a sleep mode, and turning off the laser, in response to the reception of the first sleep message and/or the first signal for sleep; and/or transmit a second wakeup message and/or a second signal of a laser for wakeup, to wake up the RU, in response to the reception of the first wakeup message and/or the first signal for wakeup.

The above modules 901A and/or 902A may be implemented as a pure hardware solution or as a combination of software and hardware, e.g., by one or more of: a processor or a microprocessor and adequate software and memory for storing of the software, a Programmable Logic Device (PLD) or other electronic component(s) or processing circuitry configured to perform the actions described above, and illustrated, e.g., in FIG. 2. Further, the apparatus 900A may comprise one or more further modules, each of which may perform any of the steps of the method 200 described with reference to FIG. 2.

Correspondingly to the method 700 as described above, an exemplary apparatus implemented in a baseband unit (BBU) connected to a transport node in a Fronthaul is provided. The Fronthaul comprises one or more transport nodes and is further connected to at least one Radio Unit (RU). FIG. 9B is a block diagram of the apparatus 900B according to an embodiment of the present disclosure.

The apparatus 900B may be configured to perform the method 700 as described above in connection with FIG. 7. As shown in FIG. 9B, the apparatus 900B may comprise: a determining module 901A configured to determine a first sleep message, a first wakeup message, a first signal for sleep, and/or a first signal for wakeup; and a transmitting module 902B configured to transmit the first sleep message or the first signal for sleep to the transport node, so as to transit the RU to a sleep mode by receiving a second sleep message or a second signal of laser for sleep, and/or transmit the first wakeup message or the first signal for wakeup to the transport node, so as to wake up the RU by receiving a second sleep message or a second signal of laser for wakeup.

The above module 910B may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 7. Further, the apparatus 900B may comprise one or more further modules, each of which may perform any of the steps of the method 700 described with reference to FIG. 7.

Although the computing devices described herein (e.g., transport nodes, BBUs, RUs) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

1. A method at a transport node in a Fronthaul, wherein the transport node is connected to at least one Radio Unit (RU) and at least one Baseband Unit (BBU) is connected to the Fronthaul via the transport node or another transport node in the Fronthaul, the method comprising:
receiving a first sleep message, a first wakeup message, a first signal for sleep, and/or a first signal for wakeup, originated from the BBU; and
transmitting a second sleep message and/or a second signal of a laser for sleep, to transit the RU to a sleep mode, and turning off the laser, in response to the reception of the first sleep message and/or the first signal for sleep; and/or
transmitting a second wakeup message and/or a second signal of a laser for wakeup, to wake up the RU, in response to the reception of the first wakeup message and/or the first signal for wakeup.

2. The method according to claim 1, further comprising: shutting down a Small Form Factor Pluggable (SPF) module, in response to the reception of the first sleep message and/or the first signal for sleep.

3. The method according to claim 1, further comprising: storing a mapping relationship between the at least one RU and at least one corresponding transport port.

4. The method according to claim 1, further comprising:
determining the second sleep message and/or the second signal of a laser for sleep, based on the first sleep message and/or the first signal for sleep; or
determining the second wakeup message and/or the second signal of a laser for wakeup, based on the first wakeup message and/or the first signal for wakeup.

5. The method according to claim 1, wherein the first sleep message, the first wakeup message, the first signal for sleep, and/or the first signal for wakeup, is received directly from the BBU, or from another transport node.

6. The method according to claim 1, wherein the first or second sleep message comprises a first timer for sleep, and/or the first or second wakeup message comprises a second timer for awake.

7. The method according to claim 1, wherein the first or second sleep message and/or the first or second wakeup message comprises at least one of the followings: BBU identifier, sequence number, message type, message length, RU identifier.

8. The method according to claim 1, wherein the first or second sleep message and/or the first or second wakeup message is received via unicast or multicast.

9. The method according to claim 8, wherein the multicast is based on a Link Layer Discovery Protocol (LLDP).

10. The method according to claim 1, wherein the reception of the sleep message and/or the wakeup message is secured by LLDP authentication header, Internet Protocol Security (IPsec), Secure Sockets Layer (SSL), and/or Media Access Control security (MACsec).

11. A method at a baseband unit (BBU) connected to a transport node in a Fronthaul, wherein the Fronthaul comprises one or more transport nodes and is further connected to at least one Radio Unit (RU), the method comprising:
determining a first sleep message, a first wakeup message, a first signal for sleep, and/or a first signal for wakeup; and
transmitting the first sleep message or the first signal for sleep to the transport node, so as to transit the RU to a sleep mode by receiving a second sleep message or a second signal of laser for sleep, and/or
transmitting the first wakeup message or the first signal for wakeup to the transport node, so as to wake up the RU by receiving a second sleep message or a second signal of laser for wakeup.

12. The method according to claim 11, wherein the first or second sleep message comprises a first timer for sleep, and/or the first or second wakeup message comprises a second timer for awake.

13. The method according to claim 11, wherein the first or second sleep message and/or the first or second wakeup message comprises at least one of the followings: BBU identifier, Sequence number, message type, message length, RU identifier.

14. The method according to claim 11, wherein the first or second sleep message and/or the first or second wakeup message is transmitted via unicast or multicast.

15. The method according to claim 14, wherein the multicast is based on a Link Layer Discovery Protocol (LLDP).

16. The method according to-any claim 11, wherein the transmission of the sleep message and/or the wakeup message is secured by LLDP authentication header, Internet Protocol Security (IPsec), Secure Sockets Layer (SSL), and/or Media Access Control security (MACsec).

17-18. (canceled)

19. An apparatus implemented in a baseband unit (BBU) connected to a transport node in a Fronthaul, wherein the Fronthaul comprises one or more transport nodes and is further connected to at least one Radio Unit (RU), the apparatus comprising:
one or more processors; and
one or more memories comprising computer program codes;
wherein the one or more memories and the computer program codes are configured to, with the one or more processors, cause the apparatus at least to:
determine a first sleep message, a first wakeup message, a first signal for sleep, and/or a first signal for wakeup; and
transmit the first sleep message or the first signal for sleep to the transport node, so as to transit the RU to a sleep mode by receiving a second sleep message or a second signal of laser for sleep, and/or
transmit the first wakeup message or the first signal for wakeup to the transport node, so as to wake up the RU by receiving a second sleep message or a second signal of laser for wakeup.

20-24. (canceled)
